(19) United States
(12) Patent Application Publication
(10) Pub. No.: US 2004/0036858 A1
(43) Pub. Date: Feb. 26, 2004

(54) LENS CHECKING APPARATUS

(76) Inventors: Roger Biel, Frankfurt am Main (DE); Anette Therese Lang-Scholl, Munchen (DE)

Correspondence Address: THOMAS HOXIE, NOVARTIS, CORPORATE INTELLECTUAL PROPERTY, ONE HEALTH PLAZA 430/2, EAST HANOVER, NJ, 07936-1080, US

(21) Appl. No.: 09/920,690

(22) Filed: Apr. 9, 2003

Related U.S. Application Data
(63) Continuation of application No. PCT/EP00/00769, filed on Jan. 31, 2000.

(30) Foreign Application Priority Data
Feb. 2, 1999 (DE) 29901791.5

(51) Int. Cl. G01B 9/00

(52) U.S. Cl. 356/124

(57) ABSTRACT

The invention provides a lens checking apparatus with which it is possible to automate the optical end control of ophthalmic lenses, especially contact lenses. To this end, the lens checking apparatus comprises a container to receive a lens to be examined, an illuminating device with at least one light source and a condenser to illuminate the lens and an image receiving device to receive the image of the lens, whereby the light beam from the light source has a predetermined wavelength and a CCD camera is provided as the image receiving device

The invention relates to a lens checking apparatus for the quality control of ophthalmic lenses, especially for the quality control of contact lenses.

Various types of lens checking apparatus have been proposed for the quality control of ophthalmic lenses. These recognise optical defects of ophthalmic lenses. It is necessary for lenses to undergo random end control, especially in the case of automatic lens manufacturing processes, since flaws and other inhomogeneous surface defects of the lens can only be detected with difficulty by an automatic image recognition system integrated into their manufacture.

The use of a shadow graph to examine ophthalmic lenses is thus known. A shadow graph uses the shadow method, with which flaws and streaks are made visible. A light source that is as punctiform as possible illuminates a projection screen directly if the light source is transmitted only through completely homogeneous media. The light source in question is generally a filament lamp or a discharge lamp. Moreover, the use of halogen lamps is also known. However, if an inhomogeneity is introduced between the light source and the screen, e.g. a rising current of warm air, then its silhouette is clearly recognised on the screen. This is because the warm gases have a lower refractive index than the normal ambient air, and the two gas masses mix together unevenly. The result is an interruption of the regular course of the beam, which is manifested by irregularly variable brightness on the screen.

In shadow graphs, there is a transparent container between the light source and the screen, which receives the lens to be examined. If a soft contact lens is to be examined, this container is filled with a liquid, preferably a physiological saline. The liquid keeps the contact lens in a swollen state. In order to obtain an enlargement of the object to be examined, an objective lens is provided in the path of the beam between the receiving container and the projection screen. Between the light source and the object, a condenser is provided, which receives the light coming from the light source in as large an angle as possible, and directs it so that it penetrates the object to be examined without great losses and as homogeneously as possible. The container with the lens to be examined is displaceable in the direction of the optical axis, enabling a sharp image of the individual sections of the curved lens to be projected on the screen. In addition, the container itself is shaped like a dish, so that it acts like a lens when it is full.

In an automatic lens manufacturing process, the optical end control of the lenses was previously carried out manually, with the result that only a random selection of lenses could undergo end control. However, this is very time-consuming and labour-intensive. In addition, manual checking is prone to errors, since which flaws are recognised and which are not depends on the individual operator. Apart from detecting defects, in the random manual end control of the contact lenses, the lens diameter is also determined. To do this, the contact lens is transferred to another container that has appropriate calibration markings, but this is very complicated and time-consuming.

The invention is concerned with the problem of providing a lens checking apparatus, with which it is possible to automate the optical end control of ophthalmic lenses, especially contact lenses. Furthermore, it should be easier to determine the diameter of the lenses.

The invention solves this problem with the features indicated in claim 1. As far as further essential refinements are concerned, reference is made to the dependent claims.

By using a light source to emit a light beam with a predetermined wavelength and replacing the objective lens and the projection screen with a CCD camera, it is possible to automate the image recording and the checking of ophthalmic lenses. The images that are taken digitally by the CCD camera are stored in a computer and are thus available in a computer-aided image processing and documentation system. The images of different lenses can be compared with one another, thus making a statistical defect analysis possible. In addition, with the automatic image recognition and processing, the diameter is determined directly on the screen without the necessity to transfer the lenses.

Further details and advantages of the invention may be seen from the description that follows and the drawing. In the drawing,

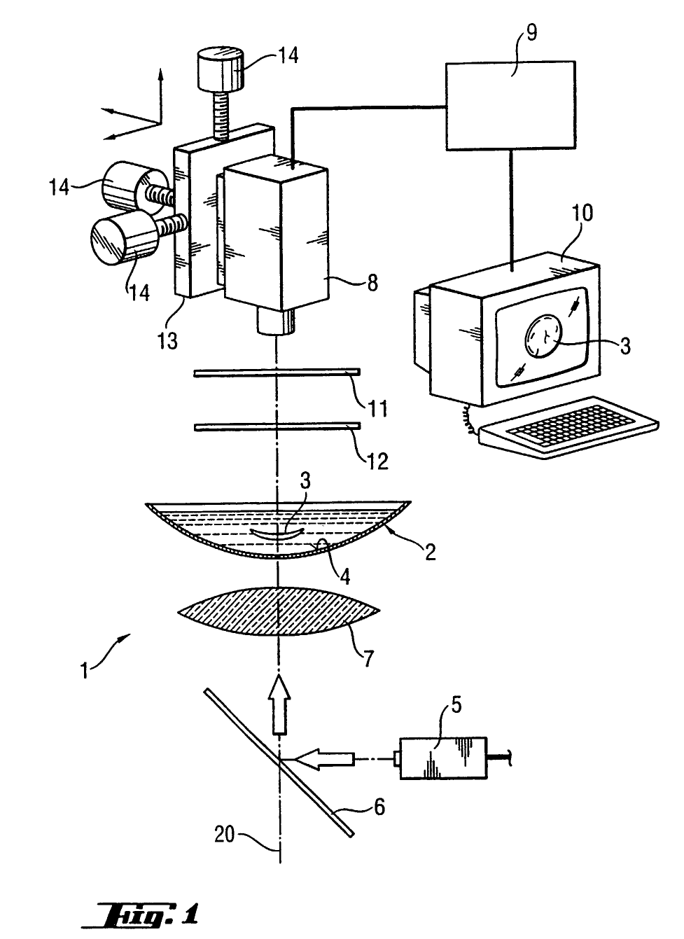

FIG. 1 shows a schematic illustration of an embodiment of a lens checking apparatus according to the invention.

In FIG. 1, a lens checking apparatus 1 is illustrated. The lens checking apparatus comprises a transparent container 2, which is filled with a liquid. The liquid is preferably distilled water or physiological saline. In order to be examined, an ophthalmic lens to be checked, preferably a contact lens 3, is suitably placed in the container 2 using a pincette, the front face of the contact lens facing the bottom 4 of the container 2. The container 2 is preferably of concave shape, so that it acts like a lens when it is full. In addition, the container 2 is kept in a holder that can be displaced towards the optical axis 20. To illuminate the contact lens 3, a light-emitting diode (LED) 5 is provided, preferably an IR-diode 5 with a wavelength of λ=880 nm. However, within the context of the invention, other diodes with other wavelengths may also be used. The light of the IR-diode 5 is reflected by a mirror 6 and directed to a condenser lens 7 which concentrates the light so that it penetrates the container 2 in a manner that is as homogeneous and parallel as possible. It is also possible to dispense with the light reflection using a mirror 6, but in this set-up of the diode 5 directly below the container 2 which is filled with liquid, there is a danger that when the container 2 is filled, drops of liquid might drop onto the diode 5. The illuminated contact lens 3 is processed by a CCD camera 8, which feeds the image of the contact lens 3 to a computer 9, where it can be seen by a monitor 10 and can be evaluated by means of a computer-aided image-processing system. The defects in question may be cavities, tears, inclusions, contamination, leakages from the edge and the like, which can be detected by an automatic image analysis system. Apart from these defects, the diameter of the contact lens can also be determined automatically using appropriate software. The images of different lenses may also be stored, so that statistical information about the appearance of various types of defects can be given.

The halogen or tungsten single-filament lamps normally used in lens checking apparatus emit a spectrum of wavelengths. A lens, however, has the characteristic of possessing a refractive index, which changes with the wavelength of the light and is described as dispersion or diffusion. Therefore, the image of an object to be examined is influenced by the wavelength with which it is observed. If several wavelengths are used, then images of the object are produced, which are reproduced at slightly different places, so that over all the resolution of the image of the object to be examined deteriorates. By using an illuminating light beam which has a certain wavelength, the resolution of the image of the contact lens to be examined may therefore be increased, so that structures that cannot be recognised with conventional illumination become visible. The increased resolution, with which the image of the contact lens is reproduced through the use of a monochromatic light source, enables a CCD camera to be used, which in turn allows computer-aided image processing to be used. On the other hand, if the image has only relatively low resolution, the use of a CCD camera is made difficult.

Normally, a CCD camera has an IR filter at its aperture area, which shades out the incoming infrared light. Since, however, the IR diode employed emits infrared light, this filter is preferably removed and suitably replaced by a cut-on filter 11 which shades out the visible light, so that imaging errors from diffused light are avoided. Moreover, grey filters 12 may be conveniently employed, which allow light reduction of the incoming beam of light. Furthermore, however, the light intensity of the diode 5 itself can also be controlled.

The CCD camera used conveniently has 768×574 pixels. However, it may also be advantageous to use a high-resolution CCD camera with a pixel count of for example 1000×1000 or even 4000×4000, in order to be able to analyse further structures. In particular, by using a high-resolution camera, a larger image section with a very high resolution can be observed.

In addition, the CCD camera may advantageously be secured to an x-y-z cradle 13, which is suitably driven by stepping motor units 14, thus enabling computer-aided control of the cradle 13. By entering corresponding x-y coordinates, the CCD camera can thus bring up five areas of the contact lens 3 that are to be examined more closely. A shift in the z-direction offers an additional possibility of focussing the image of the contact lens.

In all, the invention offers the possibility of automating the random end control of contact lenses for surface defects and of providing computer-aided image processing. This type of automated end control is of advantage in particular for contact lenses produced in large unit numbers (disposable lenses).

What we claim is

1. Lens checking apparatus for the optical control of ophthalmic lenses, preferably contact lenses, comprising a container (2) to receive a lens to be examined, an illuminating device with at least one light source (5) which emits a light beam, and a condenser (7) to illuminate the lens and an image receiving device to receive the image of the lens, whereby the light beam from the light source (5) has a predetermined wavelength and a CCD camera (8) is provided as the image receiving device.

2. Lens checking apparatus according to claim 1, whereby the light source (5) has a wavelength in the region of λ=600-1000 nm.

3. Lens checking apparatus according to claim 1 or 2, whereby a light-emitting diode (LED) is provided as the light source (5).

4. Lens checking apparatus according to claim 3, whereby an IR diode is provided as the light source (5).

5. Lens checking apparatus according to claim 4, whereby the IR diode has a wavelength of λ=880 nm.

6. Lens checking apparatus according to one or more of claims 1 to 5, whereby a cut-on filter (11) is provided in front of the CCD camera (8).

7. Lens checking apparatus according to one or more of claims 1 to 6, whereby a high-resolution CCD camera (8) is used.

8. Lens checking apparatus according to one or more of claims 1 to 7, whereby the CCD camera (8) is movable by means of an x-y cradle (13).

9. Lens checking apparatus according to one or more of claims 1 to 7, whereby the CCD camera (8) is movable by means of an x-y-z cradle (13).

10. Lens checking apparatus according to claim 8 or 9, whereby the cradle (13) is controllable by stepping motor units (14).

11. Lens checking apparatus according to one or more of claims 1 to 10, whereby the CCD camera (8) is linked to a computer (9), the image of the lens (3) taken by the CCD camera (8) being stored in the computer (9), and testing of the lens (3) being carried out by means of an automatic software-supported image analysis system.
